(19) United States
(12) Patent Application Publication
(10) Pub. No.: US 2006/0294041 A1
(43) Pub. Date: Dec. 28, 2006

(54) Installing a component to an application server

(75) Inventors: Randall Paul Baartman, Rochester, MN (US); Surya V. Duggirala, Eagan, MN (US); Matthew Ara Goshgarian, Rochester, MN (US); Bhushan Kamiakar Lokhande, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/165,382

(22) Filed: Jun. 23, 2005

(51) Int. Cl. G06F 17/30

(52) U.S. Cl. 707/1

(57) ABSTRACT

A method, apparatus, system, and signal-bearing medium that, in an embodiment, receive configuration data from a development environment, determine a component based on reading an identifier of the component from a list of all possible components, install the component to an application server if the component exists in the configuration data but is not already installed in the application server, and remove the component from the application server if the component is already installed in the application server but does not exist in the configuration data. A rule is determined for the component based on policy data, where the configuration data may include the policy data. Either the application server or the component is configured via the rule. In this way, components may be automatically installed and tuned in an application server.

### FIELD

This invention generally relates to computer systems and more specifically relates to installing a component to an application server in a computer system.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated computer software has evolved to take advantage of the higher performance of the hardware, resulting in computer systems today that are much more powerful than just a few years ago.

One use of these more powerful computer systems is to implement application servers, which execute applications and provide services for security, data access, and persistence. Applications, which are composed of components, are usually created in a development environment, such as with WSAD (Websphere Studio Application Developer). When the user has finished developing an enterprise application using the development environment, the next step is to set up the production environment for the application. (In the production environment, the enterprise application is running and available to respond to requests from clients.) Setting up the production environment includes installing an application server, such as Websphere, installing the enterprise application, and then configuring the application server to fit the needs of the specific application. The application server can be tuned differently depending on the hardware specifications of the server and the manner in which the enterprise application was written. For example, if certain components are not required by the application, installing them only serves to waste valuable resources and delay start up time of the application. Unfortunately, not all users install and tune the application server to optimize performance efficiency, mainly because they lack the information on how to do so.

What is needed is an improved technique for automatically installing and tuning applications into an application server.

### SUMMARY

A method, apparatus, system, and signal-bearing medium are provided that, in an embodiment, receive configuration data from a development environment, determine a component based on reading an identifier of the component from a list of all possible components, install the component to an application server if the component exists in the configuration data but is not already installed in the application server, and remove the component from the application server if the component is already installed in the application server but does not exist in the configuration data. A rule is determined for the component based on policy data, where the configuration data may include the policy data. Either the application server or the component is configured via the rule. In this way, components may be automatically installed and tuned in an application server.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of example configuration data, according to an embodiment of the invention.

FIG. 3 depicts a flowchart of example processing for an automatic installation, according to an embodiment of the invention.

FIG. 4 depicts a flowchart of example processing for handling configuration data, according to an embodiment of the invention.

FIG. 5 depicts a flowchart of example processing for handling an application server, according to an embodiment of the invention.

FIG. 6 depicts a flowchart of example processing for handling policy data, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

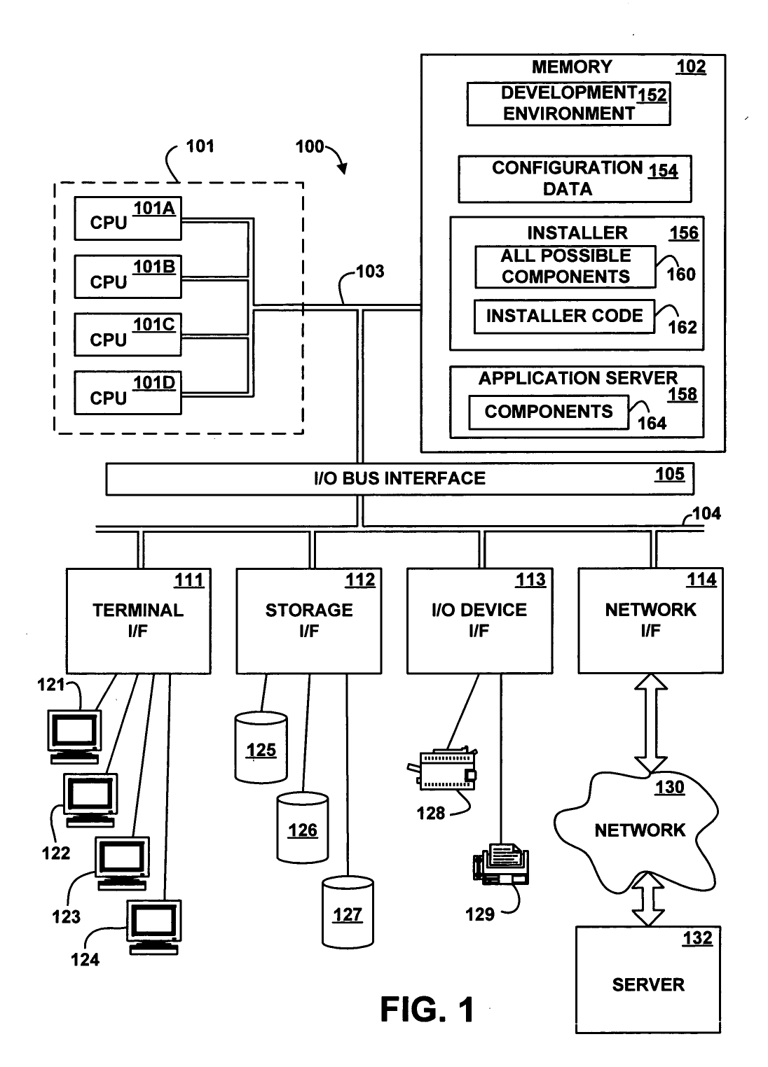

Referring to the Drawings, wherein like numbers denote like parts throughout the several views, FIG. 1 depicts a high-level block diagram representation of a computer system 100 connected via a network 130 to servers 132, according to an embodiment of the present invention. The terms “computer” and “server” are used for convenience only, and an electronic device that acts as a server in one embodiment may act as a client in another embodiment, and vice versa. In an embodiment, the hardware components of the computer system 100 may be implemented by an eServer iSeries computer system available from International Business Machines of Armonk, N.Y. However, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, the main memory 102 may exist in multiple levels of caches, and these caches may be further divided by function, so that one cache holds instructions while another holds non-instruction data, which is used by the processor or processors. The main memory 102 may be further distributed and associated with different CPUs or sets of CPUs, as is known in any of various so-called non-uniform memory access (NUMA) computer architectures.

The main memory 102 includes a development environment 152, configuration data 154, an installer 156, and an application server 158. Although the development environment 152, the configuration data 154, the installer 156, and the application server 158 are illustrated as being contained within the memory 102 in the computer system 100, in other embodiments some or all of them may be on different computer systems (for example, the servers 132) and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the development environment 152, the configuration data 154, the installer 156, and the application server 158 are illustrated as being contained within the main memory 102, these elements are not necessarily all completely contained in the same storage device at the same time. Further, although the development environment 152, the configuration data 154, the installer 156, and the application server 158 are illustrated as being separate entities, in other embodiments some of them, or portions of some of them, may be packaged together.

In an embodiment, the application server 158 is implemented via Websphere. In another embodiment, the application server 158 is a component-based product that resides in the middle-tier of a server-centric architecture. The application server 158 provides middleware services for security and state maintenance, along with data access and persistence. In an embodiment, the application server 158 is a Java application server based on the Java 2 Platform, Enterprise Edition (J2EE), but in other embodiments any appropriate platform may be used. J2EE uses a multi-tier distributed model, which generally includes a client tier, a middle tier, and an EIS (Enterprise Information System) tier. The client tier can be one or more applications or browsers. The J2EE Platform is in the middle tier and consists of a web server and an EJB (Enterprise Java Beans) server. (These servers are also called “containers.”) Additional sub-tiers in the middle tier may also exist. The EIS tier has the existing applications, files, and databases. For the storage of business data, the J2EE platform uses a database that is accessible through a JDBC (Java Database Connectivity), SQLJ (Structured Query Language for Java), or JDO API (Java Data Objects Application Program Interface). The database may be accessible from web components, enterprise beans, and application client components. The application server 158 includes components 164. Examples of the components 164 include a web container, an EJB container, a JMS (Java message service), or any other appropriate component.

The development environment 152 is a program that assists a computer programmer in developing the configuration data 154. The development environment 152 produces the configuration data 154 as output. In various embodiments, the development environment 152 may include a source code editor, a compiler and/or interpreter, build-automation tools, a debugger, a version control system, tools to simplify the construction of a GUI (Graphical User Interface), a class browser, an object inspector, and a class hierarchy diagram. In an embodiment, the development environment 152 may be implemented via an enhanced WSAD (Websphere Studio Application Developer), but in another embodiment the development environment 152 may be implemented via any appropriate development environment.

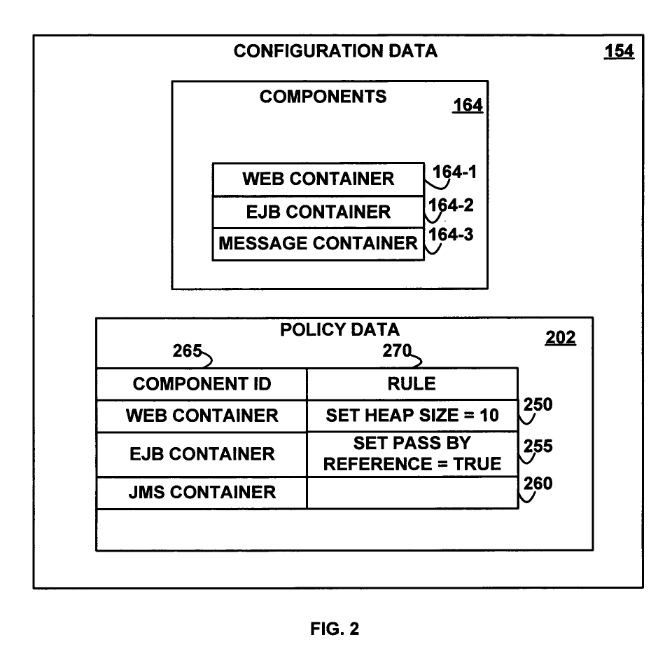

The configuration data 154 represents an application that can be deployed in the application server 158. In an embodiment, the configuration data 154 may be implemented as an ear file (Enterprise Archive file) that represents a J2EE application that can be deployed in a WebSphere application server, but in other embodiments any appropriate type of configuration data may be used. Ear files are standard Java archive files (jar files) and have the same format. An ear file can consist of one or more web application modules, one or more EJB modules, one or more application client modules, additional jar files required by the application, and any combination thereof. The modules that make up ear files are themselves packaged in archive files specific to their types; for example, a Web module contains Web archive files and an EJB module contains Java archive files. Ear files also contain a deployment descriptor (e.g., an XML file) that describes the contents of the application and contains instructions for the entire application, such as security settings to be used in the run-time environment. The configuration data 154 is further described below with reference to FIG. 2.

The installer 156 includes a list of all possible components 160 and installer code 162. The installer code 162 installs the components 164 into the application server 158 based on the configuration data 154. In various embodiments, the installer code 162 may be an operating system, a portion of an operating system, an application, an application programming interface (API), a browser, a browser plug-in, or any other appropriate function. The installer code 162 includes instructions capable of executing on the processor 101 or statements capable of being interpreted by instructions executing on the processor 101 to perform the functions as further described below with reference to FIGS. 2, 3, 4, 5, and 6. In another embodiment, the installer code 162 may be implemented in microcode or firmware. In another embodiment, the installer code 162 may be implemented in hardware via logic gates and/or other appropriate hardware techniques in lieu of or in addition to a processor-based system.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

The servers 132 may include some or all of the hardware and/or software elements previously described above for the computer system 100. In another embodiment, the servers 132 are optional, not present, or not used.

It should be understood that FIG. 1 is intended to depict the representative major components of the computer system 100, the network 130, and the servers 132 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of tangible signal-bearing media, which include, but are not limited to the following computer-readable media:

(1) information permanently stored on a non-rewriteable storage medium, e.g., a read-only memory storage device attached to or within a computer system, such as a CD-ROM, DVD-R, or DVD+R;

(2) alterable information stored on a rewriteable storage medium, e.g., a hard disk drive (e.g., the DASD 125, 126, or 127), CD-RW, DVD-RW, DVD+RW, DVD-RAM, or diskette; or

(3) information conveyed by a communications or transmissions medium, such as through a computer or a telephone network, e.g., the network 130.

Such tangible signal-bearing media, when carrying or encoded with computer-readable, processor-readable, or machine-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of example configuration data 154, according to an embodiment of the invention. The configuration data includes components 164 and policy data 202. The components 164 include example components 164-1, 164-2, and 164-3, but in other embodiments any number of components and any appropriate type of component may be present. Each of the components 164-1, 164-2, and 164-3, represents an example component of an application that may be installed to the application server 158.

The policy data 202 includes records 250, 255, and 260, but in other embodiments any number of records with any appropriate data may be present. Each of the records 250, 255, and 260 includes a component identifier field 265 and a rule field 270. In other embodiments more or fewer fields may be present.

The component identifier field 265 identifies a component 164 that may be installed in the application server 158. The rule field 270 identifies a rule that is to be applied to the application server 158 or the component 164 if the component 164 identified by the corresponding component identifier field 265 is installed. For example, the rule 270 in the record 250 indicates a heap size setting for the associated component 265 in the application server 158, and the rule 270 in the record 255 indicates whether parameters are to be passed within the associated component 265 in the application server 158 by reference or by value. In an embodiment, the rules 270 may be performance tuning rules for the application server 158, but in other embodiments any appropriate rules may be used.

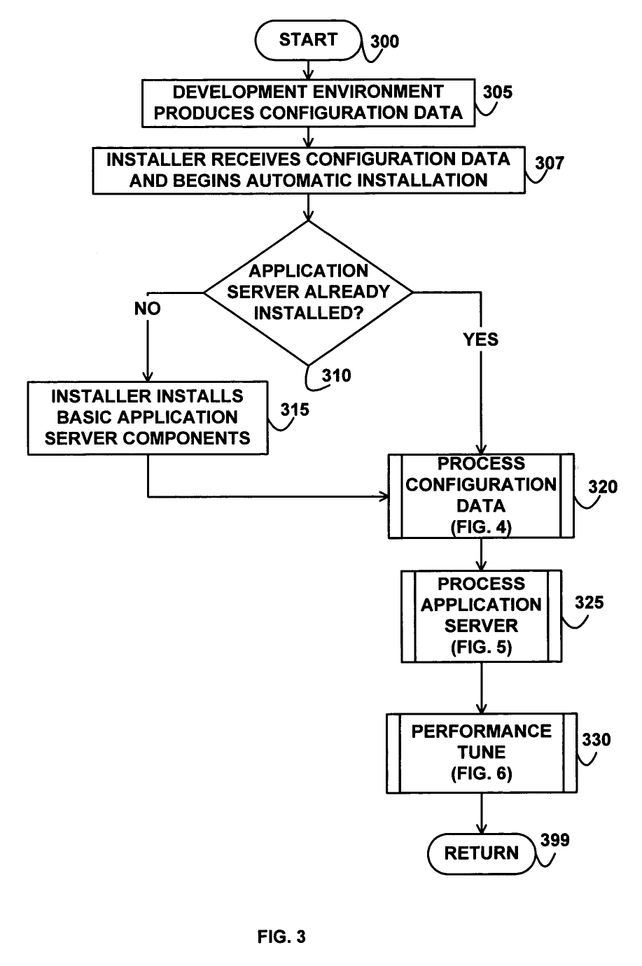

FIG. 3 depicts a flowchart of example processing for an automatic installation, according to an embodiment of the invention. Control begins a block 300. Control then continues to block 305 where the development environment 152 produces the configuration data 154. Control then continues to block 307 where the installer code 162 receives the configuration data 154 and begins the automatic installation process. The same configuration data 154 may be used by multiple different installers 156 to install the components 164 to multiple different application servers 158.

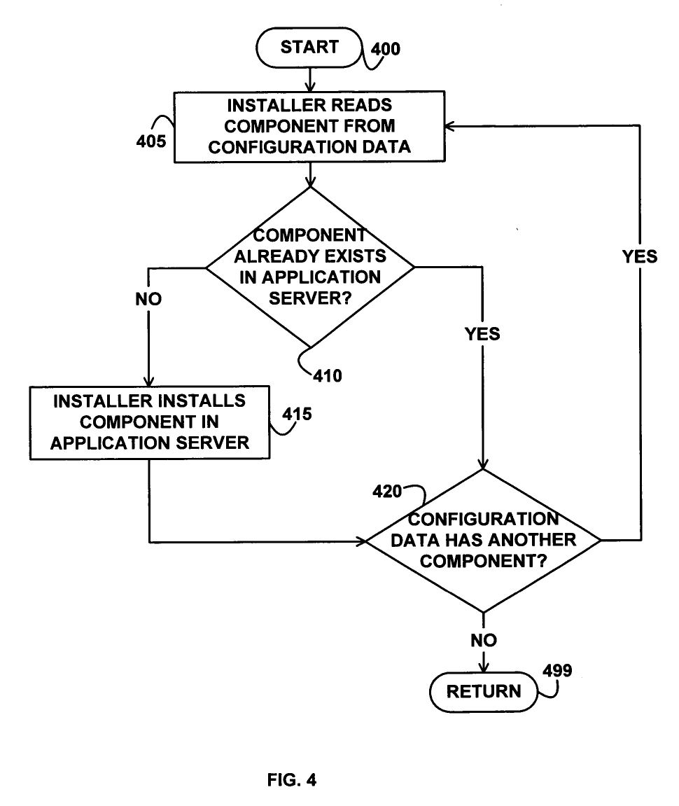

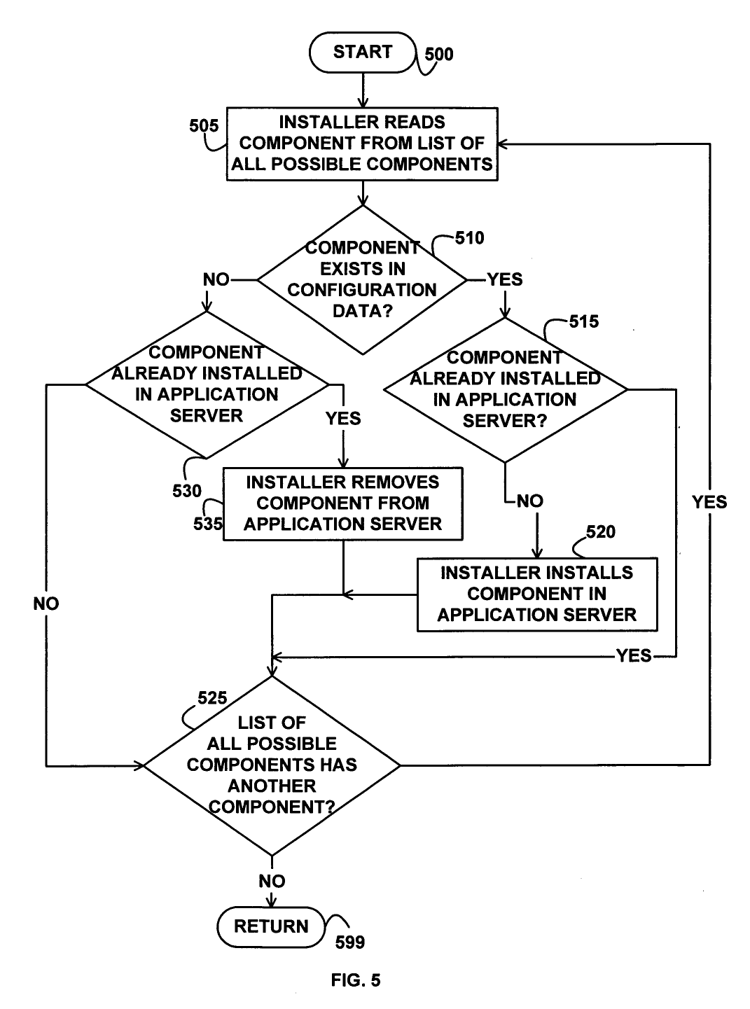

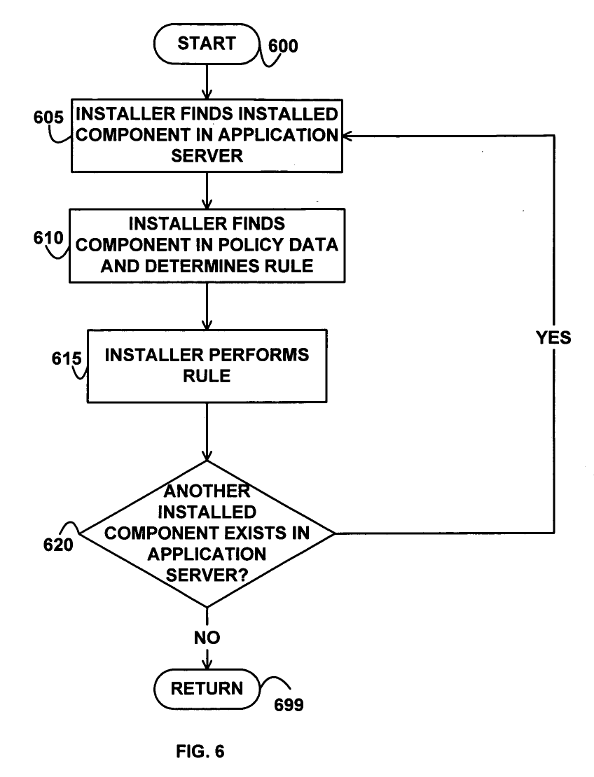

Control then continues to block 310 where the installer code 162 determines whether the application server 158 is already installed. If the determination at block 310 is true, then the application server 158 is already installed, so control continues to block 320 where the installer code 162 processes the configuration data 154, as further described below with reference to FIG. 4. Control then continues to block 325 where the installer code 162 processes the application server 158, as further described below with reference to FIG. 5. Control then continues to block 330 where the installer code 162 tunes performance of the application server 158 via the policy data 202, as further described below with reference to FIG. 6. Control then continues to block 399 where the logic of FIG. 3 returns.

If the determination at block 310 is false, then the application server 158 is not already installed, so control continues to block 315 where the installer code 162 installs basic application server components from the configuration data 154, which in an embodiment includes security, naming, and directory services. Control then continues to block 320, as previously described above.

FIG. 4 depicts a flowchart of example processing for handling the configuration data 154, according to an embodiment of the invention. Control begins at block 400. Control then continues to block 405 where the installer code 162 reads a component 164 from the configuration data 154. Control then continues to block 410 where the installer code 162 determines whether the component 164 read from the configuration data 154 is already installed in the application server 158. If the determination at block 410 is true, then the component 164 is already installed in the application server 158, so control continues to block 420 where the installer code 162 determines whether the configuration data 154 contains another component 164. If the determination at block 420 is true, then the configuration data 154 contains another component 164, so control returns to block 405 where the installer code 162 reads the next component 164 from the configuration data 154, as previously described above.

If the determination at block 420 is false, then the configuration data 154 does not contain another component 164, so control continues to block 499 where the logic of FIG. 4 returns.

If the determination at block 410 is false, then the component 164 does not already exist in the application server 158, so control continues from block 410 to block 415 where the installer code 162 installs the component 164 to the application server 158. Control then continues to block 420, as previously described above.

FIG. 5 depicts a flowchart of example processing for handling the application server 158, according to an embodiment of the invention. Control begins at block 500. Control then continues to block 505 where the installer code 162 reads an identifier of a component from the list of all possible components 160. Control then continues to block 510 where the installer code 162 determines whether the read component exists in the configuration data 154. If the determination at block 510 is true, then the read component exists in the configuration data 154, so control continues from block 510 to block 515 where the installer code 162 determines whether the component is already installed in the application server 158. If the determination at block 515 is true, then the component is already installed in the application server 158, so control continues to block 525 where the installer code 162 determines whether the list of all possible components 160 has another component. If the determination at block 525 is true, then the list of all possible components 160 has another component, so control returns to block 505, where the installer code 162 reads the next component from the list of all possible components 160, as previously described above.

If the determination at block 525 is false, then the list of all possible components 160 does not contain another component, so control continues from block 525 to block 599 where the logic of FIG. 5 returns.

If the determination at block 515 is false, then the component is not already installed in the application server 158, so control continues from block 515 to block 520 where the installer code 162 installs the component in the application server 158. Control then continues to block 525, as previously described above.

If the determination at block 510 is false, then the read component does not exist in the configuration data 154, so control continues from block 510 to block 530 where the installer code 162 determines whether the read component is already installed in the application server 158. If the determination at block 530 is true, then the component is already installed in the application server 158, so control continues from block 530 to block 535 where the installer code 162 removes the component from the application server 158. Control then continues to block 525, as previously described above.

If the determination at block 530 is false, then the component is not already installed in the application server 158, so control continues from block 530 to block 525, as previously described above.

FIG. 6 depicts a flowchart of example processing for handling the policy data 202, according to an embodiment of the invention. Control begins at block 600. Control then continues to block 605 where the installer code 162 finds an installed component 164 in the application server 158. Control then continues to block 610 where the installer code 162 finds the installed component in the policy data 202 and determines the rule 270 based on the component identifier 265 of the installed component 164. Control then continues to block 615 where the installer code 162 performs the rule to configure the application server 158 or to configure the component 164 (identified by the associated component identifier 265) in the application server 158. Control then continues to block 620 where the installer code 162 determines whether another installed component 164 exists in the application server 158. If the determination at block 620 is true, then another installed component 164 exists in the application server 158, so control returns to block 605, as previously described above. If the determination at block 620 is false, then another installed component 164 does not exist in the application server 158, so control continues from block 620 to block 699 where the logic of FIG. 6 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

What is claimed is:

1. A method comprising:
installing a component to an application server if the component exists in configuration data but is not already installed in the application server; and
removing the component from the application server if the component is already installed in the application server but does not exist in the configuration data.

2. The method of claim 1, further comprising:
determining the component based on reading an identifier of the component from a list of all possible components.

3. The method of claim 1, further comprising:
determining a rule for the component based on policy data, wherein the configuration data comprises the policy data.

4. The method of claim 3, further comprising:
configuring the application server via the rule.

5. The method of claim 3, further comprising:
configuring the component via the rule.

6. The method of claim 3, wherein the rule comprises a heap size.

7. The method of claim 3, wherein the rule comprises a pass parameter by reference indicator.

8. The method of claim 1, further comprising:
receiving the configuration data from a development environment.

9. A signal-bearing medium encoded with instructions, wherein the instructions when executed comprise:
receiving configuration data from a development environment;
installing a component to an application server if the component exists in the configuration data but is not already installed in the application server; and
removing the component from the application server if the component is already installed in the application server but does not exist in the configuration data.

10. The signal-bearing medium of claim 9, further comprising:
determining the component based on reading an identifier of the component from a list of all possible components.

11. The signal-bearing medium of claim 9, further comprising:
determining a rule for the component based on policy data, wherein the configuration data comprises the policy data.

12. The signal-bearing medium of claim 11, further comprising:
configuring the application server via the rule.

13. The signal-bearing medium of claim 11, further comprising:
configuring the component via the rule.

14. The signal-bearing medium of claim 11, wherein the rule comprises a heap size.

15. The signal-bearing medium of claim 11, wherein the rule comprises a pass parameter by reference indicator.

16. A method for configuring a computer, comprising:
configuring the computer to receive configuration data from a development environment;
configuring the computer to determine a component based on reading an identifier of the component from a list of all possible components;
configuring the computer to install the component to an application server if the component exists in the configuration data but is not already installed in the application server;
configuring the computer to remove the component from the application server if the component is already installed in the application server but does not exist in the configuration data; and
configuring the computer to determine a rule for the component based on policy data, wherein the configuration data comprises the policy data.

17. The method of claim 16, further comprising:
configuring the computer to configure the application server via the rule.

18. The method of claim 16, further comprising:
configuring the computer to configure the component via the rule.

19. The method of claim 16, wherein the rule comprises a heap size.

20. The method of claim 16, wherein the rule comprises a pass parameter by reference indicator.
